(19) United States
(12) Patent Application Publication
(10) Pub. No.: US 2024/0420588 A1
(43) Pub. Date: Dec. 19, 2024

(54) Error Diagnosis And Feedback

(71) Applicant: Microsoft Technology Licensing, LLC, Redmond, WA (US)

(72) Inventors: Wenshan WU, Redmond, WA (US); Yan XIA, Redmond, WA (US); Shaoguang MAO, Redmond, WA (US); Frank Kao-Ping K. SOONG, Redmond, WA (US); Jonathan Y. TIEN, Redmond, WA (US)

(21) Appl. No.: 18/703,655

(22) PCT Filed: Sep. 26, 2022
(86) PCT No.: PCT/US2022/044651

§ 371 Date: Apr. 22, 2024

(30) Foreign Application Priority Data
Oct. 27, 2021 (CN) 202111258233.8

(51) Int. Cl. G09B 7/08

(52) U.S. Cl. CPC G09B 7/08

(57) ABSTRACT

According to implementations of the subject matter described herein, there is provided a solution for error diagnosis and feedback. In the solution, a signal sequence is obtained; it is determined, based on a learning object, that an error is detected at a target position of the signal sequence; and a target error pattern corresponding to the target position of the signal sequence is detected. In accordance with a determination that the target error pattern matches one of a plurality of predetermined error patterns associated with the target position, a target feedback corresponding to the matched predetermined error patter is selected from a plurality of feedbacks corresponding to the plurality of predetermined error patterns; and the target feedback is provided. Through this solution, more accurate and effective feedback on different error patterns can be provided.

### BACKGROUND

When learning new skills, learners expect to have their learning results evaluated and have feedback to discover and correct errors, thereby achieving effective learning. For example, in language learning, to effectively learn correct pronunciation of a language, a learner expects to obtain evaluation and feedback on his pronunciation of the language, so as to discover and correct pronunciation errors. To this end, the learner may usually obtain the evaluation and feedback on the learning result by means of a learning assistance tool or by communicating with a teacher. However, some existing learning assistance tools may not be intelligent enough and can hardly discover errors accurately and provide effective feedback. On the other hand, during the learning process, it is usually difficult for the learners to communicate with the teachers anytime and anywhere to obtain timely and accurate evaluation and feedback. Therefore, it is very desirable for the learners to obtain accurate evaluation and effective feedback on the learning results in a convenient way.

### SUMMARY

According to implementations of the subject matter described herein, there is provided a solution for error diagnosis and feedback. In the solution, a signal sequence is obtained; it is determined, based on a learning object, that an error is detected at a target position of the signal sequence; a target error pattern corresponding to the target position of the signal sequence is detected. In accordance with a determination that the target error pattern matches one of a plurality of predetermined error patterns associated with the target position, a target feedback corresponding to the matched predetermined error patter is selected from a plurality of feedbacks corresponding to the plurality of predetermined error patterns; the target feedback is provided. Through this solution, more accurate and effective feedback on different error patterns can be provided.

The Summary is to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

FIG. 1 illustrates a block diagram of an environment in which various implementations of the subject matter described herein can be implemented;

FIG. 2 illustrates a block diagram of an example structure of an error diagnosis and feedback system in accordance with some implementations of the subject matter described herein;

FIG. 3A and FIG. 3B illustrate examples of a user interface for diagnosis and correction in accordance with some implementations of the subject matter described herein;

FIG. 4 illustrates a flowchart of an overall process for diagnosis and correction in accordance with some implementations of the subject matter described herein;

FIG. 5 illustrates a flowchart of an error pattern mining process in accordance with some implementations of the subject matter described herein;

FIG. 6 illustrates a flowchart of a process for error pattern matching in accordance with some implementations of the subject matter described herein;

FIG. 7 illustrates a flowchart of an example method in accordance with some implementations of the subject matter described herein; and

FIG. 8 illustrates a block diagram of a computing device in accordance with some implementations of the subject matter described herein.

Throughout the drawings, the same or similar reference symbols refer to the same or similar elements.

### DETAILED DESCRIPTION OF EMBODIMENTS

Principles of the subject matter described herein are now described with reference to some example implementations. It is to be understood that these implementations are described only for the purpose of illustration and help those skilled in the art to better understand and thus implement the subject matter described herein, without suggesting any limitation to the scope of the subject matter disclosed herein.

As used herein, the term “includes” and its variants are to be read as open terms that mean “includes, but is not limited to.” The term “based on” is to be read as “based at least in part on.” The terms “an implementation” and “one implementation” are to be read as “at least one implementation.” The term “another implementation” is to be read as “at least one other implementation.” The term “first,” “second,” and the like may refer to different or the same objects. Other definitions, either explicit or implicit, may be included below.

As used herein, the term “model” may learn an association between corresponding input and output from training data, and thus after the training, a corresponding output may be generated for a given input. The generation of the model may be based on machine learning techniques.

Deep learning is one of machine learning algorithms that processes the input and provides the corresponding output using a plurality of layers of processing units. A neural network model is an example of a deep learning-based model. As used herein, “model” may also be referred to as “machine learning model”, “learning model”, “machine learning network” or “learning network”, which are used interchangeably herein.

Generally, machine learning may include three stages, i.e., a training stage, a test stage, and an application stage (also referred to as an interference stage). In the training stage, a given model may be trained using a great amount of training data, with parameter values being iteratively updated until the model can obtain, from the training data, consistent interference that meets an expected target. Through the training, the model may be considered as being capable of learning an association between the input and the output (also referred to as an input-to-output mapping) from the training data. The parameter values of the trained model are determined. In the test stage, a test input is applied to the trained model to test whether the model can provide a correct output, so as to determine the performance of the model. In the application stage, the model may be used to process a real-world input based on the parameter values obtained from the training and to determine the corresponding output.

As stated above, during the learning process, it is very desirable to obtain accurate evaluation and effective feedback on the learning result in a convenient way. However, it is often difficult for existing learning assistance tools to accurately discover errors, and the feedback provided to the users (learners) is relatively general.

Take oral practice in language learning as an example. There have been some applications that can support the teaching based on “recording comparison”. A user may record and upload audio about the pronunciation of sentences, words, or phrases. By comparing the audio updated by the user with standard audio teaching, it is possible to determine whether the pronunciation of the user is accurate and to score the pronunciation accuracy of sentences, words or phrases. A scoring result may be provided as feedback. For sentences, words, or phrases with low scores in the pronunciation of the user, some applications may provide audio or video regarding their standard pronunciations.

However, such applications usually cannot perform pronunciation diagnosis to a fine degree, and the information provided by the scores and general feedback is also very monotonous and limited. As a result, it is difficult for the user to effectively learn, from such diagnosis and feedback, differences among a wrong pronunciation, an inaccurate pronunciation and a correct pronunciation, and accordingly it is impossible for the user to correct the pronunciation purposefully.

According to implementations of the subject matter described herein, there is provided an improved solution for automatic error diagnosis and feedback. The solution can provide targeted feedbacks for finer-grained errors. Specifically, for a learning object (e.g., oral language learning about a specific sentence, phrase, word, or the like), an error at a specific position and an error pattern are determined from a corresponding learning result signal sequence (e.g., an audio signal sequence of pronunciation), and by means of pattern matching, it is determined whether the error pattern at that position matches a predetermined error pattern. A plurality of associated predetermined error patterns may be determined in advance for the specific position. For different error patterns, different feedbacks may be provided accordingly, e.g., different feedbacks associated with pronunciation correction. By detecting a specific error pattern that occurs in a learning activity, it is possible to provide accurate and effective feedback specific to that error pattern. The detection of the error pattern and the provision of the target feedback may be performed automatically, thereby improving the convenience in use by the user and allowing the user to achieve a more flexible and efficient learning process of the learning object.

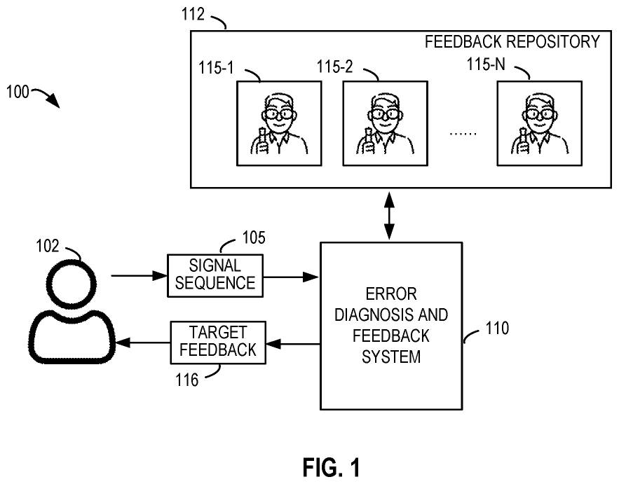

FIG. 1 illustrates a block diagram of an example environment 100 in which various implementations of the subject matter described herein can be implemented. In the environment 100, an error diagnosis and feedback system 110 is provided for performing automatic error diagnosis and feedback for a learning process of a user 102.

In FIG. 1, the error diagnosis and feedback system 110 may be any system with a computing capability. It should be appreciated that components and arrangements in the environment shown in FIG. 1 are only examples, and a computing system suitable for implementing example implementations depicted in the subject matter described herein may include one or more different components, other components, and/or different arrangement manners.

In operation, the error diagnosis and feedback system 110 obtains a signal sequence 105. The signal sequence 105 may represent a learning result for a specific learning object, and may include information in one or more forms. The learning object and the learning result are related to a specific learning process.

In oral language learning, the learning object may include learning of pronunciation of various language elements such as sentences, phrases, words and vowels, and the learning result may include the user's pronunciation practice result of corresponding language elements such as sentences, phrases, words and vowels. Correspondingly, the signal sequence 105 may include an audio signal sequence of the pronunciation input by the user. In some implementations, the signal sequence 105 may further include a video signal sequence of the pronunciation, which includes not only audio information but also visual information for presenting changes in shapes of the user's mouth.

According to the implementations of the subject matter described herein, in addition to the language learning, the error diagnosis and feedback system 110 may also be adapted to other learning scenarios as long as learning activities in those scenarios may be recorded as signal sequences and compared with learning objects in a pattern-matching manner. Another example scenario may include sports training. The training object of the user may include action learning, for example, sports actions such as golf swing and standing long jump, and the learning result include the training result of the user for those actions. Such training result may be recorded as the signal sequence 105 in various ways. For example, the signal sequence 105 may include a video signal sequence about the training actions of the user. In other examples, the signal sequence 105 may additionally or alternatively include information sensed by sensors, used for recording movements of key joints or parts of the user during the action practice. It should be appreciated that other types of learning scenarios may also exist.

In the following, for ease of understanding, some example implementations of the subject matter described herein will be discussed mainly by referring to the oral language practice in language learning as an example.

After the signal sequence 105 is obtained, the error diagnosis and feedback system 110 is configured to determine whether there is an error in the signal sequence 105 and to provide a feedback. The error diagnosis and feedback system 110 may access to and maintain a feedback repository 112 that includes a plurality of feedbacks 115-1, 115-2, . . . 115-N (collectively or individually referred to herein as feedbacks 115) associated with the learning object, where N is an integer greater than or equal to one. The error diagnosis and feedback system 110 may determine, from the plurality of feedbacks 115, a target feedback 116 for the error occurring in the signal sequence 105 and provide it to the user 102.

The feedback may provide helpful information for the user 102 to recognize and correct the error. For example, the feedback may include explanations about the related error, demonstration exercise for learning objects, and/or other related auxiliary or extended information. The provision of the feedback enables the user to conveniently and quickly conduct practices purposefully based on the feedback. For example, in oral language practice, the feedback may be related to pronunciation correction, and may, for example, include correction of a certain pronunciation error, demonstration of a correct pronunciation, other extended learning information about the incorrect or correct pronunciation, and so on. In sports training, the feedback may be related to action correction, and may, for example, include correction of a wrong action trajectory or posture, explanation and demonstration of a correct action trajectory or posture, other extended learning information about the wrong or correct action trajectory, and so on.

The feedback may be provided in various ways. In some implementations, the feedback may be a recorded video clip. The feedback may additionally or alternatively include information in other forms, such as image information, audio information, and the like. The information contained in the feedback may depend on the specific learning object and/or specific error pattern, which is served to provide helpful information for the user to recognize and correct the error accurately and effectively, and to allow convenient use for the user.

In the implementations of the subject matter described herein, it is desirable to provide the user with more fine-grained, accurate, and targeted feedback. Some specific implementations of error diagnosis and feedback in the subject matter described herein will be discussed in more detail below.

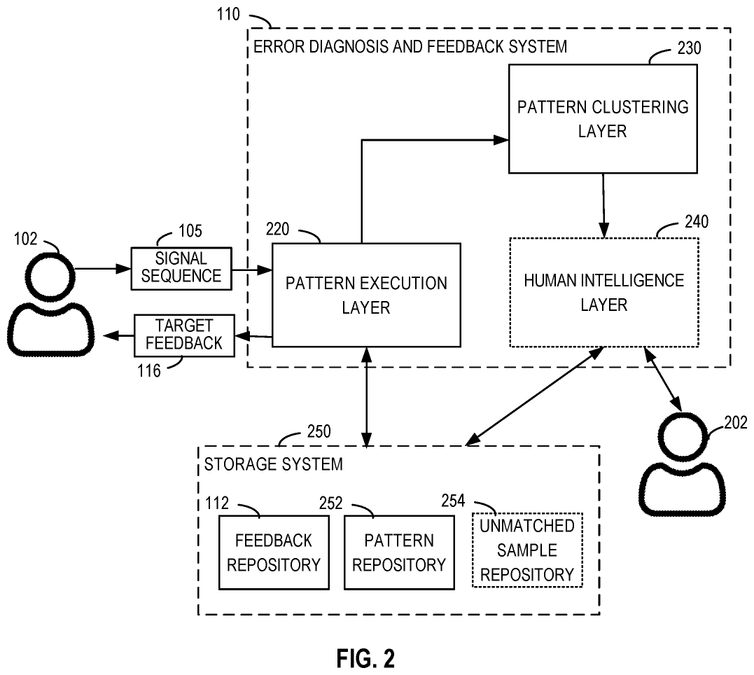

FIG. 2 illustrates a block diagram of an example structure of the error diagnosis and feedback system 110 in accordance with some implementations of the subject matter described herein. As shown in FIG. 2, the error diagnosis and feedback system 110 may include a pattern execution layer 220, a pattern clustering layer 230, and optionally a human intelligence layer 240.

In the implementations of the subject matter described herein, the pattern execution layer 220 is configured to perform error pattern detection for the signal sequence 105. The error pattern detection includes error diagnosis and error pattern extraction. The pattern execution layer 220 may detect whether there is an error at any position of the signal sequence 105 and determine, if there is an error, whether the error pattern matches a predetermined error pattern. If the error matching the predetermined error pattern is found, the pattern execution layer 220 provides a feedback corresponding to the matched predetermined error pattern.

Upon the error diagnosis in the error pattern detection, the pattern execution layer 220 determines whether there is an error at any position of the signal sequence 105 based on the learning object. The determined error is determined with respect to the learning object. In some implementations, the error diagnosis may be performed using a standard signal sequence for the same learning object. For example, in the scenario of language learning, the standard signal sequence may include an audio signal sequence of a standard pronunciation of a language element such as a sentence, phrase, word, vowel, or the like in a specific language; in the scenario of action training, the standard signal sequence may include a video signal sequence recording standard actions. When determining whether there is an error at any position of the signal sequence 105, the pattern execution layer 220 may determine whether there is a differences between signal segments at respective positions of the signal sequence 105 and signal segments at the same positions of the standard signal sequence, and determine whether there is an error at a certain position based on the difference.

Upon receiving the signal sequence 105, the pattern execution layer 220 may determine the standard signal sequence corresponding to the signal sequence 105. For example, in some application scenarios, the user 102 may perform oral practice on a learning object, such as a sentence, phrase, word, vowel, or the like that is contained in a given language learning textbook, by means of follow-up reading, and provide a recorded audio signal sequence. In this way, an audio signal sequence of the standard pronunciation may represent the learning object in the corresponding language learning teaching textbook, and the learning object corresponding to the audio signal sequence of the pronunciation of the user may be determined based on the user input.

In some implementations, the pattern execution layer 220 may perform error diagnosis on the signal sequence 105 at one or more granularity levels. Different granularity levels may correspond to different learning elements of the learning object. The granularity level for diagnosing errors in the signal sequence 105 may be set according to the learning application scenario. For example, in language learning, each diagnostic position may correspond to a position corresponding to an individual phoneme in a language learning object, or may be a position corresponding to an individual syllable or word, and the like. Therefore, a position where an error may occur in the signal sequence 105 may be detected according to one or more of the granularity levels of phoneme, syllable, word, phrase, or the like. For example, if the learning object is the pronunciation of a sentence, an error in the audio signal sequence of the pronunciation of the user may be diagnosed at a position corresponding to learning elements at a granularity level of phoneme, syllable, word, phrase, or the like.

In some implementations, during the error diagnosis, occurrence of an error may always be detected at a relatively small granularity level or the minimum granularity level, e.g., by phoneme. In this way, whether there is an error in the pronunciation of a certain syllable or word may be determined from the detection results of pronunciation errors of a plurality of phonemes. As another example, for action learning, an occurred error may be a certain static posture error, or an error of a continuous action trajectory. Accordingly, during the error diagnosis, it is possible to determine a video frame corresponding to a specific static posture or a video segment corresponding to an action trajectory from the video signal sequence, and detect whether it is different from a standard static posture or a standard action trajectory.

The pattern execution layer 220 may utilize various techniques to perform the error diagnosis. In some implementations, the pattern execution layer 220 may align a position of a learning element in the signal sequence 105 with a position of the same learning element in the standard signal sequence by means of alignment. Then, by comparing the signal segments at different positions, it is able to determine whether an error is present. In some implementations, the pattern execution layer 220 may perform the error diagnosis using a machine learning model (also referred to as an error diagnosis model) which is trained to monitor whether there is a difference between the positions of the input signal sequence and aligned positions of the corresponding standard signal sequence, and then determine which position or positions of the input signal sequence have an error(s). In an example implementation of using the machine learning model, the machine learning model may be used to extract corresponding feature information from signal segments corresponding to respective positions in the signal sequence 105, and whether there is an error at each position may be determined based on the extracted feature information. For each position, it is possible to compare the feature information extracted from the signal segment corresponding to this position in the signal sequence 105 with the feature information extracted from the signal segment corresponding to the same position in the standard signal sequence, and determine whether there is an error at the position based on the similarity of the feature information. For example, if the difference from the feature information extracted from the standard signal sequence is relatively large (e.g., greater than a predetermined threshold), it may be determined that an error occurs at the current position.

The machine learning model used may depend on the type of signal sequence 105 to be processed. For example, the pattern execution layer 220 may use an acoustic model to detect, with respect to the standard audio signal sequence, whether there is an error in an audio signal sequence input by the user. For other signal sequences such as video signal sequences involving images or other possible auxiliary signal sequences, a computer vision technique or other suitable signal processing techniques may be used to support the error diagnosis.

Through the error diagnosis, the pattern execution layer 220 may determine whether there is an error(s) at one or more positions of the signal sequence 105. If the pattern execution layer 220 determines that there is an error(s) at one or more positions of the signal sequence 105 (such a position is sometimes referred to herein as a “target position”), it detects an error pattern (hereinafter referred to as “a target error pattern”) corresponding to the target position of the signal sequence 105 and further determines the feedback.

Unlike a traditional solution where a single and fixed form of feedback is provided for the learning object when the error occurs, in the implementation of the subject matter described herein, the pattern execution layer 220 can determine a feedback corresponding to a detected error pattern among various error patterns at different positions in the input signal sequence 105, as a target feedback 116.

During the learning process, it can be observed that for a same learning object or for a same learning element in the same learning object, various errors may occur in learning results of different users or different learning results of the same user. For example, in the oral language practice, even for the same phoneme, syllable, word or phrase, and the like, different pronunciation errors may occur in different learning results of different users of the same learning object, the same user of different learning objects, and the same user of the same learning object. For example, for a certain phoneme, the user may pronounce this phoneme incorrectly (e.g., mispronounce the phoneme as another phoneme), pronounce the phoneme badly (e.g., pronounce the phoneme as an ambiguous pronunciation between two phonemes), or produce the phoneme incorrectly during the connection and transformation between the phoneme and other phonemes. Those different errors may be divided into a plurality of error patterns and specific feedbacks (such as pronunciation corrections and improvement suggestions) may be provided to provide helpful information for the user to recognize and correct the error accurately and effectively, and greatly improve the convenience in use by the user.

In order to achieve such fine feedbacks, in the implementations of the subject matter described herein, it is possible to determine in advance multiple error patterns that may occur at respective positions of a specific learning object, and provide feedbacks corresponding to different error patterns. That is, for the same learning object such as a same sentence, a set of feedbacks may be established and are respectively mapped to different positions involved in the learning object.

Among the plurality of error patterns that may occur at a position, each error pattern may be mapped to a corresponding feedback. In this way, each feedback may be precisely configured for a specific error pattern.

In the example of FIG. 2, for the signal sequence 105, if the pattern execution layer 220 determines a target error pattern(s) corresponding to one or more target positions of the signal sequence 105, it may determine whether each target error pattern can match any of a plurality of predetermined error patterns associated with a respective target position by pattern matching. If it is determined that there is a matched predetermined error pattern, the pattern execution layer 220 obtains a feedback corresponding to the matched predetermined error pattern from the feedback repository 112 and provides it as the target feedback 116 corresponding to the target position.

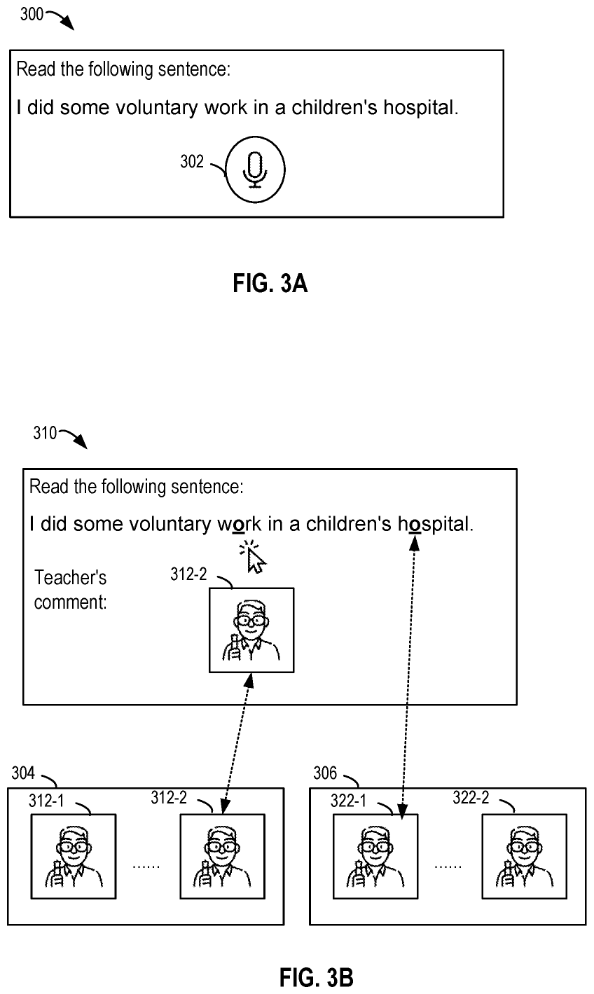

FIG. 3A and FIG. 3B illustrate examples of user interfaces for diagnosis and correction in accordance with some implementations of the subject matter described herein. In the user interface 300 of FIG. 3A, by a user click an icon 302 in the interface, a recording device such as a microphone in user equipment records an audio signal sequence of pronunciation while the user is reading the sentence presented on the interface. The audio signal sequence may be provided to the error diagnosis and feedback system 110 for analysis.

In the user interface 310 of FIG. 3B, through the error diagnosis by the error diagnosis and feedback system 110, it may be determined that when the user reads the sentence, the pronunciation of the letter “o” in the word “work” is incorrect. For example, the letter “o” in this word should be pronounced as the phoneme “ [symbol] ” but the user pronounced it as another phoneme “ [symbol] ”. In addition, the error diagnosis and feedback system 110 also determines that the user pronounces the letter “o” in the word “hospital” incorrectly. These errors may be highlighted in the user interface 310.

The word “work” in this sentence or the phoneme of the letter “o” in the word is pre-mapped to a set of feedbacks 304 which includes a plurality of feedbacks 312-1, 312-2, etc., each corresponding to a different error pattern at this position. The word “hospital” in this sentence or the phoneme of the letter “o” in the word is pre-mapped to a set of feedbacks 304 which includes a plurality of feedbacks 322-1, 322-2, etc., each corresponding to a different error pattern at this position. The error diagnosis and feedback system 110 may determine that a pronunciation error of the letter “o” in the word “work” in the pronunciation signal sequence of the user matches an error pattern to which the feedback 312-2 is mapped, so the feedback 312-2 may be determined as a target feedback on the pronunciation error of the letter “o” in the word “work”. The error diagnosis and feedback system 110 may further determine that a pronunciation error of the letter “o” in the word “hospital” in the pronunciation signal sequence of the user matches an error pattern to which the feedback 322-1 is mapped, so the feedback 312-2 may be determined as a target feedback on the pronunciation error of the letter “o” in the word “hospital”.

The corresponding target feedback is also presented in the user interface 310 automatically or in response to a user input. For example, in response to a user input, the feedback 312-2 may be presented in user interface 310 to assist the user in pronouncing the letter “o” in the word “work” correctly.

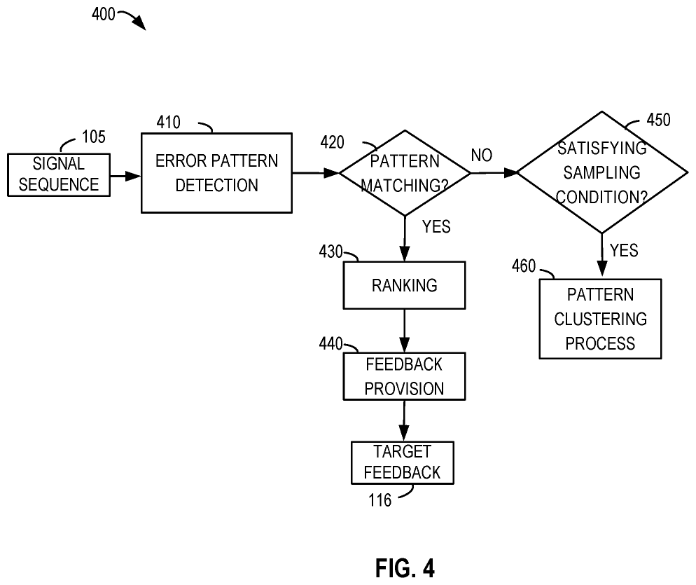

FIG. 4 illustrates a flowchart of an overall process 400 for diagnosis and correction in accordance with some implementations of the subject matter described herein. The process 400 may be implemented at the error diagnosis and feedback system 110.

At block 410, the error diagnosis and feedback system 110 performs error pattern detection 410 for the signal sequence 105 to determine whether there is an error(s) at one or more positions of the signal sequence 105, and to detect an error pattern corresponding to a position with an error in the signal sequence 105. As stated above, the error pattern detection includes error diagnosis and error pattern extraction, and may be performed by the pattern execution layer 220 in the error diagnosis and feedback system 110. The implementation of the error diagnosis may depend on the specific application, e.g., the form of the signal sequence to be analyzed.

If a target error pattern corresponding to a target position in the signal sequence 105 is detected, the error diagnosis and feedback system 110 (e.g., the pattern execution layer 220) performs pattern matching 420 to determine whether the detected target error pattern matches a plurality of predetermined error patterns associated with the corresponding target position. If there are matched predetermined error patterns, the error diagnosis and feedback system 110 (e.g., the pattern execution layer 220) performs ranking 430. Through the ranking, in a case where there are a plurality of errors in the signal sequence 105 and a plurality of matched predetermined error patterns are found, an error(s) with a higher confidence(s) and a predetermined error pattern(s) with a higher matching confidence(s) may be provided to the user based on the ranking result. Then, the error diagnosis and feedback system 110 (e.g., the pattern execution layer 220) performs feedback provision 440 to present the determined target feedback 116 to the user.

In some implementations, if an error is detected at a target position in the signal sequence 105, but its error pattern cannot be matched to any predetermined error pattern after the pattern matching, the signal sequence 105 may be collected for use in subsequent extension of the error pattern detection and pattern matching capability of the error diagnosis and feedback system 110. In some implementations, for an unmatched error pattern detected at a target position of the signal sequence 105, the error diagnosis and feedback system 110 may store the error pattern corresponding to the target position of the signal sequence 105 and an indication of the target position. In some implementations, in addition or as an alternative, the error diagnosis and feedback system 110 may store the signal sequence 105 or a signal segment at the target position of the signal sequence 105. Such information may be stored, for example, in an unmatched sample repository 254 of a storage system 250 shown in FIG. 2 for subsequent use.

In the subsequent process, the error diagnosis and feedback system 110 (e.g., the pattern clustering layer 230) determines 450 whether the information stored in the unmatched sample repository 254 satisfies a sampling condition. With the sampling condition satisfied, the error diagnosis and feedback system 110 may perform or trigger the execution of a pattern clustering process 460. The pattern clustering process 460 will be discussed below.

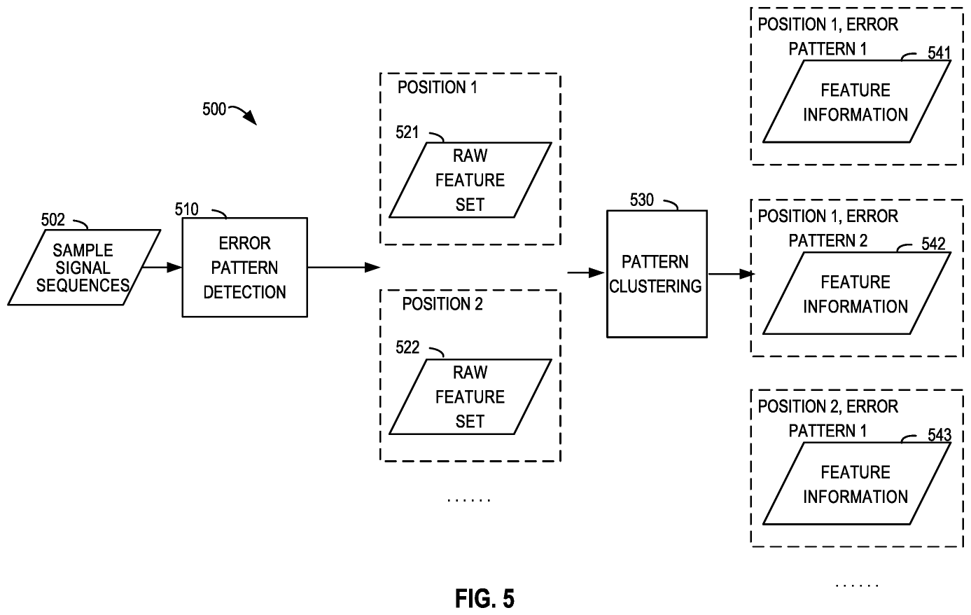

FIG. 5 illustrates a flowchart of an error pattern mining process 500 in accordance with some implementations of the subject matter described herein. The process 500 may be implemented to determine different error patterns so that corresponding feedbacks for the different error patterns may be established and stored into the feedback repository 112. The process 500 may be implemented at the error diagnosis and feedback system 110.

As shown in FIG. 5, the error diagnosis and feedback system 110 performs error pattern detection 510 to determine presence of errors and extract error patterns from a plurality of sample signal sequences 502.

At an initial stage, a predetermined error pattern(s) associated with one or more positions of a learning object may be determined through the error pattern mining process 500 in order to pre-establish feedbacks for such error patterns. In this case, the plurality of sample signal sequences 502 may be learning results collected for many times for a specific learning object. The error pattern detection may then be performed by the pattern execution layer 220 in the error diagnosis and feedback system 110 for the plurality of sample signal sequences 502 so as to determine the error patterns that may exist at positions of the sample signal sequences 502.

In some implementations, the error pattern detection may be implemented using the pattern execution layer 220 in the error diagnosis and feedback system 110. For a given sample signal sequence 502, the pattern execution layer 220 may determine, based on the corresponding learning object and using an approach the same or similar to the signal sequence 105, whether there are errors at respective positions in the sample signal sequence 502, and then detect the corresponding error patterns.

In some implementations, during the error pattern detection process, the pattern execution layer 220 may divide, from the sample signal sequence 502, a plurality of signal segments corresponding to a plurality of learning elements of the learning object, respectively. For example, in an audio signal sequence of pronunciation, signal segments corresponding to one or more granularity levels such as different phonemes, syllables, words or phrases in a sample signal sequence 502 are detected respectively. The pattern execution layer 220 may determine whether there is an error at each position by using standard signal segments corresponding to those positions in the standard signal sequence. For example, the pattern execution layer 220 may extract more feature information through a machine learning model for comparison to determine whether there is an error at each position.

In some implementations, after detecting presence of an error, the pattern execution layer 220 may extract feature information at respective positions with the errors in the sample signal sequence. The feature information extracted from each position may be used to indicate a signal feature at this position, and thus may be used to indicate an error pattern of the signal segment at this position in the case where the error is present. For all the sample signal sequences considered in the error pattern mining process, the error patterns extracted from each position are referred to as candidate error patterns. In some implementations, a specific machine learning model (also referred to as a pattern detection model) may be used to extract feature information to indicate the error patterns. The machine learning model used here may be different from the one used for error diagnosis and may use higher-level feature information to indicate the error patterns corresponding to different positions. In some implementations, it is also possible to directly use the feature information extracted by the machine learning model at the error diagnosis stage for a signal segment at a certain position to indicate the error pattern corresponding to the position.

In some implementations, to extract the feature information about a specific position, the feature extraction may be performed using only the signal segment at that position. In some implementations, context information associated with the signal segment may also be considered when extracting the feature information. For example, for a given position, the feature information corresponding to this position may be extracted from the signal segment at the given position and from at least one adjacent signal segment of the given signal segment. This may be completed by designing a sliding window on the signal sequence. In practical applications, for example, for the same phoneme, different pronunciation errors may occur in different contexts (such as with different adjacent phonemes). More possible error patterns associated with learning elements at specific positions may be covered by taking the context into account for feature extraction.

In the implementation of the extension mentioned above, a new error pattern may also be obtained by extending an unmatched error pattern collected from the signal sequence 105 through the error pattern mining process 500 during operation. In such a case, an error pattern detected at a specific position (e.g., the feature information extracted for a target position) may be directly obtained from the unmatched sample repository 254 as a candidate error pattern corresponding to the specific position. This candidate error pattern may then be used, together with other candidate error patterns at the same position, to determine the new error pattern.

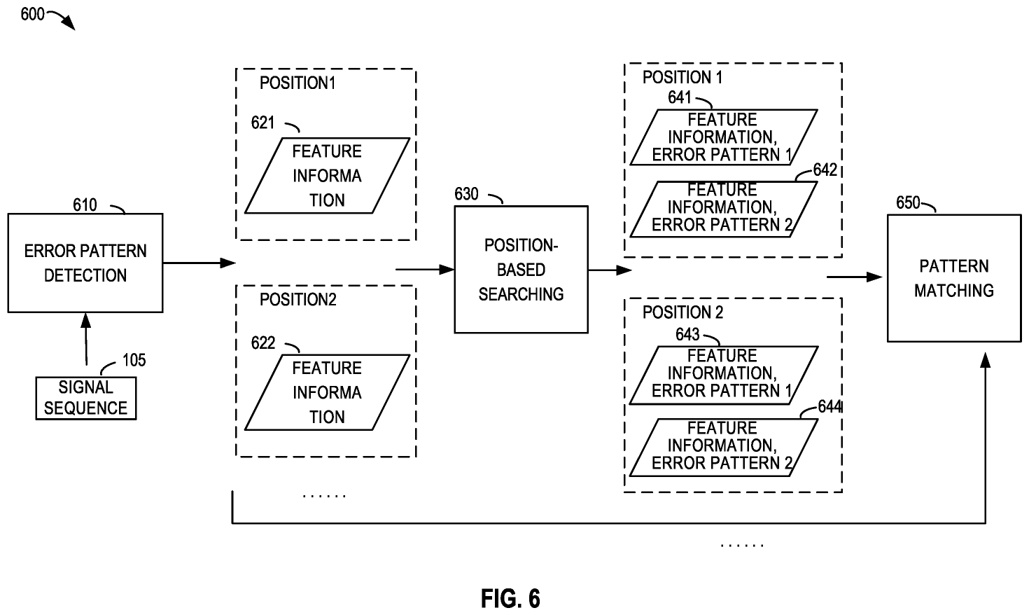

For a plurality of sample signal sequences of the same learning object (e.g., a sentence), raw feature sets at different positions (e.g., different phonemes) where errors occur may be extracted. As shown in FIG. 6, a raw feature set 521 at Position 1, a raw feature set 522 at Position 2 and so on in the sample signal sequence may be extracted. Each raw feature set includes feature information, i.e., candidate error patterns, collected from different sample signal sequences at that position.

The error diagnosis and feedback system 110 (e.g., the pattern clustering layer 230 therein) performs pattern clustering 530 to determine a plurality of predetermined error patterns from the candidate error patterns (i.e., feature information) at each position. Different error patterns may have distinguishable feature information. For a learning element (e.g., a phoneme) of a learning object (e.g., a sentence), the pattern clustering layer 230 may determine a plurality of error patterns associated with the position corresponding to the learning element by clustering. As shown in FIG. 5, for Position 1, Error Pattern 1 and corresponding feature information 541, and Error Pattern 2 and corresponding feature information 542 may be determined; for Position 2, Error Pattern 1 and corresponding feature information 543 may also be determined similarly, and so on. In some implementations, for each position, the clustered feature information may be stored in a pattern repository 252 in the storage system 250 to indicate the predetermined error patterns that may occur at respective positions. That is to say, for each position, the pattern repository 252 specifically stores the clustering results obtained after clustering the feature information extracted for the corresponding position in the sample signal sequences, that is, a plurality of feature information clusters for representing the corresponding predetermined error patterns.

In some implementations, after the plurality of predetermined error patterns associated with each position are determined by the clustering, the pattern clustering layer 230 may further trigger the human intelligence layer 240 (in FIG. 2) to establish and record specific feedbacks for the different error patterns determined at different positions. The human intelligence layer 240 may determine a feedback corresponding to a predetermined error pattern based on expert knowledge. Specifically, the human intelligence layer 240 may interact with a technician/expert 202 to obtain a feedback corresponding to a predetermined error pattern. The obtained feedback may be stored in association with the associated predetermined error pattern. For example, the feedback may be stored into the feedback repository 112 where each feedback may be mapped to one or more error patterns stored in the pattern repository 252 (e.g., these error patterns may be associated with one or more positions in one or more learning objects).

Error pattern clustering may be accomplished and the establishment of feedback may also be implemented through the process 500. FIG. 6 illustrates a flowchart of a process 600 for error pattern matching in accordance with some implementations of the subject matter described herein. The process 600 may be implemented at the error diagnosis and feedback system 110, such as at the pattern execution layer 220. The process 600 may be considered as specific implementations of the error pattern detection step and the pattern matching step in the process 400.

In the process 600, the pattern execution layer 220 performs error pattern detection 610 for the signal sequence 105 based on the learning object, and the error pattern detection 610 is similar to the error pattern detection 510 in the process 500. Through the error pattern detection, the pattern execution layer 220 may determine that there is an error(s) at certain target position(s) of the signal sequence 105. The pattern execution layer 220 may extract feature information at least from a signal segment at a target position of the signal sequence 105 by means of feature extraction, and determine a target error pattern corresponding to the target position based on the extracted feature information. In some examples, the extracted feature information may be directly used to indicate the target error pattern corresponding to the target position.

In some implementations, in extraction of the feature information, the pattern execution layer 220 may also use context information and extract the feature information from the signal segment at the target position and one or more adjacent signal segments to determine (or directly indicate) the target error pattern corresponding to the target position. That is, for a target position, the extracted feature information may include feature information extracted from the signal segment itself, or feature information extracted from the signal segment and the adjacent signal segments together. With the context information being considered, the different error patterns corresponding to the target position may be better characterized.

As shown in FIG. 6, the feature information 621 of Position 1, the feature information 622 of Position 2, and so on in the signal sequence 105 may be extracted, to indicate the target error patterns corresponding to these positions, respectively.

In some implementations, the pattern execution layer 220 may use an acoustic model to extract feature information for an audio signal sequence, and may use other machine learning models or other techniques to extract feature information of other types of signal sequences.

In the process 600, the pattern execution layer 220 performs position-based searching 630 to search for, from the pattern repository 252, feature information extracted for a plurality of positions in the standard signal sequence. As stated above, feature information may indicate an error pattern corresponding to a certain position. Each position corresponds to a position in the standard signal sequence, and may also correspond to a position in the signal sequence 105. As shown in FIG. 6, it is possible to find feature information 641 at Position 1, which indicates Error Pattern 1 associated with Position 1, and feature information 642 at Position 1, which indicates Error Pattern 2 associated with Position 1; feature information 643 at Position 2, which indicates Error Pattern 1 associated with Position 2, and feature information 644 at Position 2, which indicates Error Pattern 2 associated with Position 1; and so on.

The pattern execution layer 220 performs pattern matching 650 to compare the feature information extracted for a target position in the signal sequence 105 with feature information of a plurality of predetermined error patterns associated with the target position. The comparison of the feature information may include calculating a similarity between two sets of feature information. The feature information may be represented as a multi-dimensional vector, and thus in some implementations, the similarity may be represented by a distance between the vectors. Based on a comparison result of the feature information, for example the similarity between the feature information, the pattern execution layer 220 may determine whether a target error pattern corresponding to a certain target position of the signal sequence 105 matches a certain predetermined error pattern associated with the position. For example, if the similarity of the feature information is high, e.g., higher than a certain threshold, the pattern execution layer 220 may determine that the target error pattern detected at the target position matches the corresponding predetermined error pattern. Based on the result of the pattern matching, as stated above, the pattern execution layer 220 may provide a feedback corresponding to the matched predetermined error pattern to the user.

It should be appreciated that FIG. 5 and FIG. 6 in the above provide only some example processes of the error pattern detection and the pattern matching, and there may be other ways to detect errors and perform pattern matching from the signal sequence.

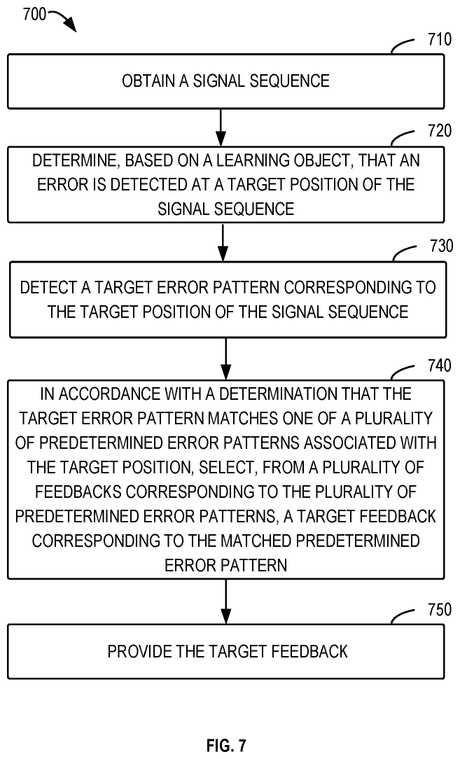

FIG. 7 illustrates a flowchart of an example method 700 in accordance with some implementations of the subject matter described herein. The method 700 may be implemented at the error diagnosis and feedback system 110 of FIG. 1.

At block 710, the error diagnosis and feedback system 110 obtains a signal sequence. At block 720, the error diagnosis and feedback system 110 determines, based on a learning object, that an error is detected at a target position of the signal sequence. At block 730, the error diagnosis and feedback system 110 detects a target error pattern corresponding to the target position of the signal sequence. At block 740, in accordance with a determination that the target error pattern matches one of a plurality of predetermined error patterns associated with the target position, the error diagnosis and feedback system 110 selects, from a plurality of feedbacks corresponding to the plurality of predetermined error patterns, a target feedback corresponding to the matched predetermined error pattern. At block 750, the error diagnosis and feedback system 110 provides the target feedback.

In some implementations, the signal sequence comprises an audio signal sequence of pronunciation, and the plurality of feedbacks comprise a plurality of video feedbacks related to pronunciation correction. In some implementations, the target position comprises a position corresponding to a phoneme, a syllable, a word, or a phrase in the audio signal sequence.

In some implementations, the signal sequence comprises a video signal sequence of an action, and the plurality of feedbacks comprise a plurality of video feedbacks related to action correction. In some implementations, the target position comprises a video clip corresponding to an action trajectory in the video signal sequence or a video frame corresponding to a statistic posture in the video signal sequence.

In some implementations, determining that an error is detected at a target position of the signal sequence comprises: extracting first feature information from a signal segment corresponding to the target position in the signal sequence, and determining, based on the extracted first feature information, that an error is detected at the target position of the signal sequence. In some implementations, detecting the target error pattern comprises: extracting second feature information at least from the signal segment corresponding to the target position in the signal sequence, and determining the target error pattern based on the extracted second feature information.

In some implementations, extracting the second feature information comprises: extracting the second feature information from the signal segment and at least one adjacent signal segment of the signal segment.

In some implementations, the plurality of predetermined error patterns are determined by: detecting a plurality of candidate error patterns corresponding to the target position in a plurality of sample signal sequences for the learning object; and determining the plurality of predetermined error patterns by clustering the plurality of candidate error patterns.

In some implementations, for a given predetermined error pattern of the plurality of predetermined error patterns, a storage system stores a clustering result of feature information extracted for the target position of at least one of the plurality of sample signal sequences that is used to determine the given predetermined error pattern.

In some implementations, the method 700 further comprises: in accordance with a determination that the target error pattern does not match the plurality of predetermined error patterns, storing feature information extracted for the target position of the signal sequence and an indication related to the target position; and determining a further error pattern associated with the target position at least based on the feature information extracted for the target position.

In some implementations, the method 700 further comprises: determining a feedback corresponding to the further error pattern based on expertise knowledge; and storing the determined feedback in association with the further error pattern.

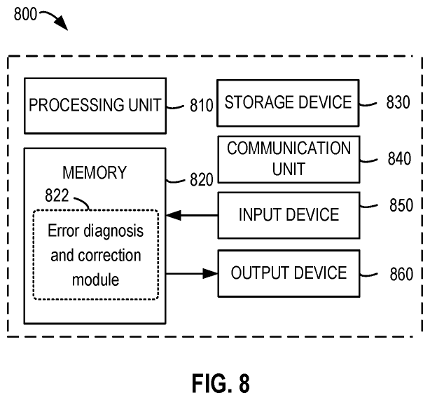

FIG. 8 illustrates a block diagram of a computing device 800 in accordance with some implementations of the subject matter described herein. It should be appreciated that the computing device 800 shown in FIG. 8 is merely provided as an example, without suggesting any limitation to the functionalities and scope of implementations of the subject matter described herein. The computing device 800 may be used to implement the error diagnosis and feedback system 110.

As shown in FIG. 8, the computing device 800 includes a computing device 800 in the form of a general-purpose computing device. Components of the computing device 800 may include, but are not limited to, one or more processors or processing units 810, a memory 820, a storage device 830, one or more communication units 840, one or more input devices 850, and one or more output devices 860.

In some implementations, the computing device 800 may be implemented as any user terminal or server terminal. The service terminal may be any server, large-scale computing device, and the like provided by various service providers. The user terminal may, for example, be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, TV receiver, radio broadcast receiver, E-book device, gaming device, or any combination thereof, including the accessories and peripherals of these devices, or any combination thereof. It is also contemplated that the computing device 800 may support any type of interface to a user (such as “wearable” circuitry and the like).

The processing unit 810 may be a physical or virtual processor and may implement various processes based on programs stored in the memory 820. In a multi-processor system, a plurality of processing units execute computer-executable instructions in parallel so as to improve the parallel processing capability of the computing device 800. The processing unit 810 may also be referred to as a central processing unit (CPU), a microprocessor, a controller, or a microcontroller.

The computing device 800 usually includes various computer storage medium. The computer storage medium may be any available medium accessible by the computing device 800, including but not limited to, volatile and non-volatile medium, or detachable and non-detachable medium. The memory 120 may be a volatile memory (for example, a register, cache, Random Access Memory (RAM)), non-volatile memory (for example, a Read-Only Memory (ROM), Electrically Erasable Programmable Read-Only Memory (EEPROM), flash memory), or any combination thereof. The memory 820 may include an error diagnosis and correction module 822 which is configured to perform the functions of various implementations described herein. The error diagnosis and feedback module 822 may be accessed and run by the processing unit 810 to implement corresponding functions.

The storage device 830 may be any detachable or non-detachable medium and may include machine-readable medium, which may be used for storing information and/or data and are accessible by the computing device 800. The computing device 800 may further include additional detachable/non-detachable, volatile/non-volatile memory medium. Although not shown in FIG. 8, it is possible to provide a disk drive for reading from or writing into a detachable and non-volatile disk, and an optical disk drive for reading from and writing into a detachable non-volatile optical disc. In such case, each drive may be connected to a bus (not shown) via one or more data medium interfaces.

The communication unit 840 communicates with a further computing device via the communication medium. In addition, the functions of components in the computing device 800 may be implemented by a single computing cluster or multiple computing machines that may communicate with each other via communication connections. Therefore, the computing device 800 may operate in a networked environment using logic connections with one or more other servers, network personal computers (PCs), or further general network nodes.

The input device 850 may include one or more of a variety of input devices, such as a mouse, a keyboard, a tracking ball, a voice-input device, and the like. The output device 860 may include one or more of a variety of output devices, such as a display, a loudspeaker, a printer, and the like. Through the communication unit 840, the computing device 800 may further communicate with one or more external devices (not shown) such as storage devices and display devices, one or more devices that enable the user to interact with the computing device 800, or any devices (such as a network card, a modem and the like) that enable the computing device 800 to communicate with one or more other computing devices, if required. Such communication may be performed via input/output (I/O) interfaces (not shown).

In some implementations, as an alternative of being integrated on a single device, some or all components of the computing device 800 may also be arranged in the form of cloud computing architecture. In the cloud computing architecture, the components may be provided remotely and work together to implement the functionalities described in the subject matter described herein.

In some implementations, cloud computing provides computing, software, data access and storage service, which will not require end users to be aware of the physical positions or configurations of the systems or hardware provisioning these services. In various implementations, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or may be installed directly or otherwise on a client device.

Some example implementations of the subject matter described herein are listed below.

In a first aspect, the subject matter described herein provides a computer-implemented method. The method comprises: obtaining a signal sequence; determining, based on a learning object, that an error is detected at a target position of the signal sequence; detecting a target error pattern corresponding to the target position of the signal sequence; in accordance with a determination that the target error pattern matches one of a plurality of predetermined error patterns associated with the target position, selecting, from a plurality of feedbacks corresponding to the plurality of predetermined error patterns, a target feedback corresponding to the matched predetermined error pattern; and providing the target feedback.

In some implementations, the signal sequence comprises an audio signal sequence of pronunciation, and the plurality of feedbacks comprise a plurality of video feedbacks related to pronunciation correction. In some implementations, the target position comprises a position corresponding to a phoneme, a syllable, a word, or a phrase in the audio signal sequence.

In some implementations, the signal sequence comprises a video signal sequence of an action, and the plurality of feedbacks comprise a plurality of video feedbacks related to action correction. In some implementations, the target position comprises a video clip corresponding to an action trajectory in the video signal sequence or a video frame corresponding to a statistic posture in the video signal sequence.

In some implementations, determining that an error is detected at a target position of the signal sequence comprises: extracting first feature information from a signal segment corresponding to the target position in the signal sequence, and determining, based on the extracted first feature information, that an error is detected at the target position of the signal sequence. In some implementations, detecting the target error pattern comprises: extracting second feature information at least from the signal segment corresponding to the target position in the signal sequence, and determining the target error pattern based on the extracted second feature information.

In some implementations, extracting the second feature information comprises: extracting the second feature information from the signal segment and at least one adjacent signal segment of the signal segment.

In some implementations, the plurality of predetermined error patterns are determined by: detecting a plurality of candidate error patterns corresponding to the target position in a plurality of sample signal sequences for the learning object; and determining the plurality of predetermined error patterns by clustering the plurality of candidate error patterns.

In some implementations, for a given predetermined error pattern of the plurality of predetermined error patterns, a storage system stores a clustering result of feature information extracted for the target position of at least one of the plurality of sample signal sequences that is used to determine the given predetermined error pattern.

In some implementations, the method further comprises: in accordance with a determination that the target error pattern does not match the plurality of predetermined error patterns, storing feature information extracted for the target position of the signal sequence and an indication related to the target position; and determining a further error pattern associated with the target position at least based on the feature information extracted for the target position.

In some implementations, the method further comprises: determining a feedback corresponding to the further error pattern based on expertise knowledge; and storing the determined feedback in association with the further error pattern.

In a second aspect, the subject matter described herein provides an electronic device. The electronic device comprises: a processing unit; and a memory coupled to the processing unit and having instructions stored thereon, the instructions, when executed by the processing unit, causing the device to perform acts of: obtaining a signal sequence; determining, based on a learning object, that an error is detected at a target position of the signal sequence; detecting a target error pattern corresponding to the target position of the signal sequence; in accordance with a determination that the target error pattern matches one of a plurality of predetermined error patterns associated with the target position, selecting, from a plurality of feedbacks corresponding to the plurality of predetermined error patterns, a target feedback corresponding to the matched predetermined error pattern; and providing the target feedback.

In some implementations, the signal sequence comprises an audio signal sequence of pronunciation, and the plurality of feedbacks comprise a plurality of video feedbacks related to pronunciation correction. In some implementations, the target position comprises a position corresponding to a phoneme, a syllable, a word, or a phrase in the audio signal sequence.

In some implementations, the signal sequence comprises a video signal sequence of an action, and the plurality of feedbacks comprise a plurality of video feedbacks related to action correction. In some implementations, the target position comprises a video clip corresponding to an action trajectory in the video signal sequence or a video frame corresponding to a statistic posture in the video signal sequence.

In some implementations, determining that an error is detected at a target position of the signal sequence comprises: extracting first feature information from a signal segment corresponding to the target position in the signal sequence, and determining, based on the extracted first feature information, that an error is detected at the target position of the signal sequence. In some implementations, detecting the target error pattern comprises: extracting second feature information at least from the signal segment corresponding to the target position in the signal sequence, and determining the target error pattern based on the extracted second feature information.

In some implementations, extracting the second feature information comprises: extracting the second feature information from the signal segment and at least one adjacent signal segment of the signal segment.

In some implementations, the plurality of predetermined error patterns are determined by: detecting a plurality of candidate error patterns corresponding to the target position in a plurality of sample signal sequences for the learning object; and determining the plurality of predetermined error patterns by clustering the plurality of candidate error patterns.

In some implementations, for a given predetermined error pattern of the plurality of predetermined error patterns, a storage system stores a clustering result of feature information extracted for the target position of at least one of the plurality of sample signal sequences that is used to determine the given predetermined error pattern.

In some implementations, the acts further comprise: in accordance with a determination that the target error pattern does not match the plurality of predetermined error patterns, storing feature information extracted for the target position of the signal sequence and an indication related to the target position; and determining a further error pattern associated with the target position at least based on the feature information extracted for the target position.

In some implementations, the acts further comprise: determining a feedback corresponding to the further error pattern based on expertise knowledge; and storing the determined feedback in association with the further error pattern.

In a third aspect, the subject matter described herein provides a computer program product being tangibly stored in a non-transitory computer storage medium and including machine-executable instructions, the machine-executable instructions, when executed by a device, causing the device to perform acts comprising: obtaining a signal sequence; determining, based on a learning object, that an error is detected at a target position of the signal sequence; detecting a target error pattern corresponding to the target position of the signal sequence; in accordance with a determination that the target error pattern matches one of a plurality of predetermined error patterns associated with the target position, selecting, from a plurality of feedbacks corresponding to the plurality of predetermined error patterns, a target feedback corresponding to the matched predetermined error pattern; and providing the target feedback.

In some implementations, the signal sequence comprises an audio signal sequence of pronunciation, and the plurality of feedbacks comprise a plurality of video feedbacks related to pronunciation correction. In some implementations, the target position comprises a position corresponding to a phoneme, a syllable, a word, or a phrase in the audio signal sequence.

In some implementations, the signal sequence comprises a video signal sequence of an action, and the plurality of feedbacks comprise a plurality of video feedbacks related to action correction. In some implementations, the target position comprises a video clip corresponding to an action trajectory in the video signal sequence or a video frame corresponding to a statistic posture in the video signal sequence.

In some implementations, determining that an error is detected at a target position of the signal sequence comprises: extracting first feature information from a signal segment corresponding to the target position in the signal sequence, and determining, based on the extracted first feature information, that an error is detected at the target position of the signal sequence. In some implementations, detecting the target error pattern comprises: extracting second feature information at least from the signal segment corresponding to the target position in the signal sequence, and determining the target error pattern based on the extracted second feature information.

In some implementations, extracting the second feature information comprises: extracting the second feature information from the signal segment and at least one adjacent signal segment of the signal segment.

In some implementations, the plurality of predetermined error patterns are determined by: detecting a plurality of candidate error patterns corresponding to the target position in a plurality of sample signal sequences for the learning object; and determining the plurality of predetermined error patterns by clustering the plurality of candidate error patterns.

In some implementations, for a given predetermined error pattern of the plurality of predetermined error patterns, a storage system stores a clustering result of feature information extracted for the target position of at least one of the plurality of sample signal sequences that is used to determine the given predetermined error pattern.

In some implementations, the acts further comprise: in accordance with a determination that the target error pattern does not match the plurality of predetermined error patterns, storing feature information extracted for the target position of the signal sequence and an indication related to the target position; and determining a further error pattern associated with the target position at least based on the feature information extracted for the target position.

In some implementations, the acts further comprise: determining a feedback corresponding to the further error pattern based on expertise knowledge; and storing the determined feedback in association with the further error pattern.

In a fourth aspect, the subject matter described herein provides a computer readable medium having machine-executable instructions stored thereon, the machine-executable instructions, when executed by a device, causing the device to perform one or more implementations of the method according to the above first aspect.

The functionalities described herein can be performed, at least in part, by one or more hardware logic components. As an example, and without limitation, illustrative types of hardware logic components that can be used include field-programmable gate arrays (FPGAs), Application-specific Integrated Circuits (ASICs), application-specific standard products (ASSPs), system-on-a-chip systems (SOCs), complex programmable logic devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in plurality of implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method comprising:
obtaining a signal sequence;
determining, based on a learning object, that an error is detected at a target position of the signal sequence;
detecting a target error pattern corresponding to the target position of the signal sequence;
in accordance with a determination that the target error pattern matches one of a plurality of predetermined error patterns associated with the target position, selecting, from a plurality of feedbacks corresponding to the plurality of predetermined error patterns, a target feedback corresponding to the matched predetermined error pattern; and
providing the target feedback.

2. The method of claim 1, wherein the signal sequence comprises an audio signal sequence of pronunciation, and the plurality of feedbacks comprise a plurality of video feedbacks related to pronunciation correction; and
wherein the target position comprises a position corresponding to a phoneme, a syllable, a word, or a phrase in the audio signal sequence.

3. The method of claim 1, wherein the signal sequence comprises a video signal sequence of an action, and the plurality of feedbacks comprise a plurality of video feedbacks related to action correction; and
wherein the target position comprises a video clip corresponding to an action trajectory in the video signal sequence or a video frame corresponding to a statistic posture in the video signal sequence.

4. The method of claim 1, wherein determining that an error is detected at a target position of the signal sequence comprises:
extracting first feature information from a signal segment corresponding to the target position in the signal sequence, and
determining, based on the extracted first feature information, that an error is detected at the target position of the signal sequence; and
wherein detecting the target error pattern comprises:
extracting second feature information at least from the signal segment corresponding to the target position in the signal sequence, and
determining the target error pattern based on the extracted second feature information.

5. The method of claim 4, wherein extracting the second feature information comprises:
extracting the second feature information from the signal segment and at least one adjacent signal segment of the signal segment.

6. The method of claim 1, wherein the plurality of predetermined error patterns are determined by: detecting a plurality of candidate error patterns corresponding to the target position in a plurality of sample signal sequences for the learning object; and determining the plurality of predetermined error patterns by clustering the plurality of candidate error patterns.

7. The method of claim 6, wherein for a given predetermined error pattern of the plurality of predetermined error patterns, a storage system stores a clustering result of feature information extracted for the target position of at least one of the plurality of sample signal sequences that is used to determine the given predetermined error pattern.

8. The method of claim 1, further comprising:
in accordance with a determination that the target error pattern does not match the plurality of predetermined error patterns, storing feature information extracted for the target position of the signal sequence and an indication related to the target position; and
determining a further error pattern associated with the target position at least based on the feature information extracted for the target position.

9. The method of claim 8, further comprising:
determining a feedback corresponding to the further error pattern based on expertise knowledge; and
storing the determined feedback in association with the further error pattern.

10. An electronic device, comprising:
a processing unit; and
a memory coupled to the processing unit and having instructions stored thereon, the instructions, when executed by the processing unit, causing the device to perform acts comprising:
obtaining a signal sequence;
determining, based on a learning object, that an error is detected at a target position of the signal sequence;
detecting a target error pattern corresponding to the target position of the signal sequence;
in accordance with a determination that the target error pattern matches one of a plurality of predetermined error patterns associated with the target position, selecting, from a plurality of feedbacks corresponding to the plurality of predetermined error patterns, a target feedback corresponding to the matched predetermined error pattern; and
providing the target feedback.

11. The device of claim 10, wherein the signal sequence comprises an audio signal sequence of pronunciation, and the plurality of feedbacks comprise a plurality of video feedbacks related to pronunciation correction; and
wherein the target position comprises a position corresponding to a phoneme, a syllable, a word, or a phrase in the audio signal sequence.

12. The device of claim 10, wherein the signal sequence comprises a video signal sequence of an action, and the plurality of feedbacks comprise a plurality of video feedbacks related to action correction; and
wherein the target position comprises a video clip corresponding to an action trajectory in the video signal sequence or a video frame corresponding to a statistic posture in the video signal sequence.

13. The device of claim 10, wherein determining that an error is detected at a target position of the signal sequence comprises:
extracting first feature information from a signal segment corresponding to the target position in the signal sequence, and
determining, based on the extracted first feature information, that an error is detected at the target position of the signal sequence; and
wherein detecting the target error pattern comprises:
extracting second feature information at least from the signal segment corresponding to the target position in the signal sequence, and
determining the target error pattern based on the extracted second feature information.

14. The device of claim 13, wherein extracting the second feature information comprises:
extracting the second feature information from the signal segment and at least one adjacent signal segment of the signal segment.

15. A computer program product being tangibly stored in a computer storage medium and comprising computer-executable instructions, the computer-executable instructions, when executed by a device, causing the device to perform acts comprising:
obtaining a signal sequence;
determining, based on a learning object, that an error is detected at a target position of the signal sequence;
detecting a target error pattern corresponding to the target position of the signal sequence;
in accordance with a determination that the target error pattern matches one of a plurality of predetermined error patterns associated with the target position, selecting, from a plurality of feedbacks corresponding to the plurality of predetermined error patterns, a target feedback corresponding to the matched predetermined error pattern; and
providing the target feedback.
